(19) United States
(12) Patent Application Publication
(10) Pub. No.: US 2015/0088992 A1
(43) Pub. Date: Mar. 26, 2015

(54) CONTROLLING PEER SOJOURN TIME IN FILE SHARING SYSTEMS

(71) Applicant: THOMSON LICENSING, Issy de Moulineaux (FR)

(72) Inventors: Stratis Ioannidis, San Francisco, CA (US); Nidhi Hegde, Paris (FR); Laurent Massoulie, Vaucresson (FR); Ji Zhu, Urbana, IL (US)

(21) Appl. No.: 14/394,374

(22) PCT Filed: Dec. 27, 2012
(86) PCT No.: PCT/US2012/071698

§ 371 Date: Oct. 14, 2014

Related U.S. Application Data
(60) Provisional application No. 61/687,965, filed on May 4, 2012.

(51) Int. Cl. H04L 29/08

(52) U.S. Cl. CPC H04L 67/104; H04L 67/06
USPC 709/204

(57) ABSTRACT

A method for controlling the average time a peer spends in a swarm of peers in a file sharing system includes first establishing an autonomous mode of operation in the swarm of peers. In the autonomous mode, peers communicate only with other peers in their swarm in order to gain access to pieces of a desired file. If the swarm size meets a threshold size, then the file sharing system switches to a universal mode. In a universal mode, peers from one swarm are permitted to exchange desired file pieces with other peers in other swarms. If the desired file pieces held by peers within a swarm meets a threshold number, then the file sharing system transitions back to the autonomous mode of operation.

### CROSS REFERENCE TO RELATED APPLICATION

This application claims priority to U.S. Provisional Application No. 61/687,965 entitled “Stable and Scalable Universal Swarms”, filed on 4 May 2012, which is hereby incorporated by reference in its entirety for all purposes.

### FIELD

The present invention relates to the efficient operation of a file sharing system. Specifically, the invention relates to the reduction of time a peer spends in a file sharing system.

### BACKGROUND

BitTorrent is one of the most popular peer-to-peer protocols, used by millions of Internet users to share files online. In simple terms, peers interested in downloading a single file from a distinguished user, termed the seed, form a so-called swarm. The distinguished seed user has a copy of the complete file. Peers download pieces of the desired file from the distinguished seed user. Peers in a swarm exchange file pieces (or chunks) they upload and download with each other. Each peer thereby acts as both a client and a server, contributing to the aggregate upload capacity of the swarm.

Assuming the seed's upload capacity is U pieces per second, there is a maximum largest arrival rate of peers λ that can be supported without the swarm growing to infinity. Intuitively, as every incoming peer increases the swarm's aggregate upload capacity, one would expect BitTorrent to support high arrival rates.

Determining the stability region of BitTorrent has been an open problem for a long time. It is known that the swarm remains stable if and only if λ<U, i.e., the arrival rate of peers does not exceed the seed's upload capacity. Consider a setup where peers act as leechers and immediately depart after downloading the file. Then, if λ>U, a single piece can become extremely rare. In this case, all arriving peers quickly download all pieces except for this missing piece, which can be obtained only from the seed. Peers wait for a very long time to obtain it and exit the system and, as a result, the swarm size grows to infinity.

This phenomenon is known as the missing piece syndrome and undermines BitTorrent's scalability: although the aggregate upload capacity of a BitTorrent swarm grows as new peers arrive, the missing piece syndrome implies this capacity is severely under-utilized. In fact, when the syndrome manifests, the seed's uplink becomes the system bottleneck.

In light of this, one approach to increasing the stability region of BitTorrent is to bundle multiple autonomous swarms together into a universal swarm. In this setup, peers again depart upon retrieving the file they are interested in. However, while still in the system, they store and exchange pieces with peers belonging to different swarms.

Intuitively, such inter-swarm exchanges utilize swarm bandwidth that would otherwise remain idle: peers unable to locate a piece they are missing can contribute their available bandwidth to aid other swarms. As such, a universal swarm with a single seed exhibits an increased stability region compared to autonomous swarms. However, sharing pieces with different swarms may introduce a trade-off between stability and the average sojourn time, i.e., the time peers spend in the system: by consuming part of their bandwidth for pieces they are not interested in, peers may take longer to retrieve the file they desire. Thus, the increased stability region of universal swarms comes at the cost of increased delays that scale with the total number of bundled swarms. That is, the greater the number of swarms, the greater the delay.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

To address the increased sojourn time experienced in establishing universal swarms to avoid the missing piece syndrome, the present invention includes a modified file sharing system design that provably extends the stability region and does not affect delays. In particular, as long as the number of swarms is of the order of the number of pieces in a file, peers experience a minimal sojourn time, i.e., of the same order as if the swarms were not bundled together. As file pieces typically number in the thousands in practice, this allows for supporting a significant number of swarms with both improved stability and low delays. In addition, they can be designed so that peers do not experience increased delays in obtaining their file.

In one aspect of the invention, multiple threshold piece selection policies are made that allow the system to alternate between autonomous and universal swarm mode behavior. In particular, whenever the system size is small, each swarm acts autonomously; the seed evenly distributes its uploading capacity to different swarms, while peers in each swarm contact only other peers within the same swarm and receive only pieces they are interested in. However, when the system size becomes high (i.e., the missing piece syndrome manifests), the system is switched to a universal mode; peers contact peers in other swarms, and receive arbitrary pieces of the file from each other and the seed. Switching to the universal mode ensures that the system is stabilized, and eventually led back to the autonomous mode.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an embodiment of peer computers that serve as an environment for the invention;

FIG. 2a illustrates the performance of an autonomous mode of operation;

FIG. 2b illustrates the performance of a universal mode of operation using a random novel (RN) policy;

FIG. 2c illustrates the performance of a universal mode of operation using a rarest first (RF) policy;

FIG. 3a illustrates the average sojourn time in the autonomous mode for different piece selection policies;

FIG. 3b illustrates the average sojourn time versus swarm size in the universal mode where each swarm comprises peers requesting a k-piece file;

FIG. 3c illustrates the average sojourn time using principles of the invention where each swarm comprises peers requesting a k-piece file;

FIG. 4 illustrates an example flow diagram of a use according to aspects of the invention;

FIG. 5 illustrates an example file system swarm tracker according to aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

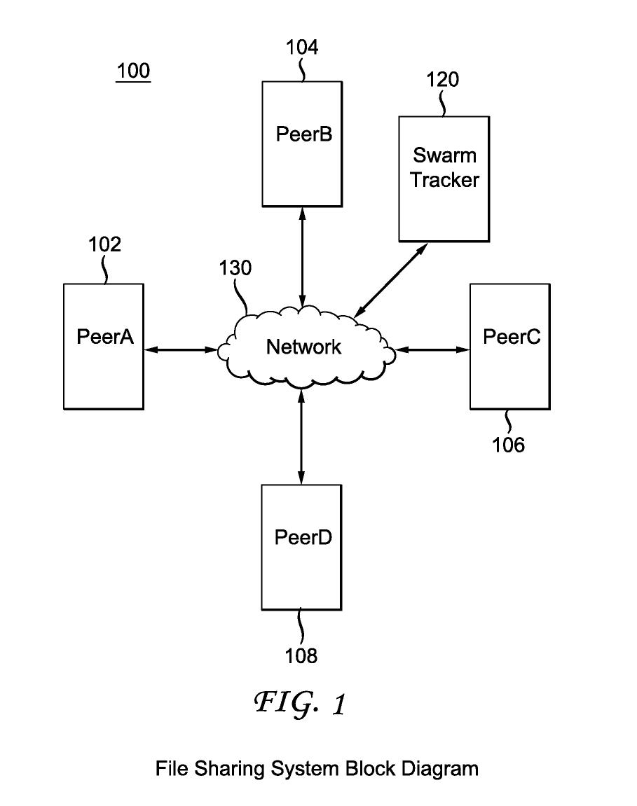

FIG. 1 depicts a file sharing system 100 which can serve as an environment for implementation of the present invention. FIG. 1 illustrates a BitTorrent-like file sharing system where four peers are shown. Those skilled in the art recognize that any number of peer devices can be interconnected. Peer A 102 is connected to the network 130 as are Peer B 104, Peer C 106, Peer D 108, and swarm tracker 120. Network 130 may be any form of private or public network such as an Intranet or an Internet that supports multiple network devices. In another embodiment, network 130 may be a wireless network supporting a multiplicity of wireless devices. Peers A, B, C, and D are example network devices capable of transferring information across the network 130 to other network devices. Examples of such network devices include remote terminals, personal desktop computers, laptop computers, or any type of computing device having a network interface. Peers A, B, C, and D can be either wired to the network 130 or wirelessly connected to the network 130, or a combination of both. Swarm tracker 120 is a networked device which can act as a distinguished user or seed. The swarm tracker contains the capability to determine operation of the system 100 by affecting the way peers respond to swarms. The swarm tracker acts as a centralized control for the file sharing system 100 by monitoring the performance of the system 100 and by controlling the modes of operation of the system 100.

In one BitTorrent-like system, such as in FIG. 1, peers looking to gather a file swarm together to form a single swarm. This is called autonomous mode. However, as explained herein, if peer having a missing piece exits the swarm, the remaining peers in the swarm cannot gain the missing file piece and the swarm can grow uncontrollably. In another BitTorrent-like file-sharing system consisting of multiple swarms: peers in each swarm wish to download the same file, and all files are stored by a single seed. Peers in different swarms collaborate, forming thus a universal swarm. This is called the universal mode of operation. File pieces are shared across all swarms: each peer contacts other peers from different swarms, and transfers to them pieces it carries. Further, the seed may upload pieces that peers do not explicitly request. Nevertheless, peers immediately depart upon receiving all pieces of the file they are interested in. Below, this peer and seed behavior in a universal mode is described in detail.

Recall that a distinguished peer, the seed, is always present and holds copies of all requested files. Files are divided into pieces of equal size. Define by [symbol] ={1, 2, . . . , K} the set of all pieces held by the seed. Represent a file C as a non-empty subset of [symbol] , i.e., C ∈ 2 [symbol] \{} (where 2 [symbol] is the power set of F). Refer to the set of peers interested in downloading file C as the swarm of file C. Peers in this swarm arrive according to a Poisson process with rate and arrivals are independent across different swarms. Denote by C the set of files whose arrival rate is non-zero, i.e.,

C:={C:C∈2 [symbol] \{0},λ_{C}>0}

and by λₜₒₜₐₗ:=ΣC:C∈cλ_{C} the total arrival rate in the system. It is not required that the sets in C are disjoint; as such, our model naturally also captures a scenario where arriving peers are interested in multiple files.

Each peer maintains a cache, in which it stores pieces it downloads. Assume that peers arrive with empty caches, and that each peer's cache is large enough to hold all K pieces in [symbol] . Peers depart immediately upon retrieving all pieces of the file they are interested in. Partition peers into types according to (a) the swarm they belong to and (b) the set of pieces in their cache. Hence, a peer of swarm C holding a set of pieces S is denoted to be of type [symbol] C,S [symbol] . According to these assumptions, only peers of type [symbol] C,S [symbol] ∈T exist in the system, where T is defined as follows:

T:={ [symbol] C,S [symbol] :C∈C,S∈2 [symbol] \{F},C [symbol] S} Eq. (1)

Set the seed to be of type [symbol] {⊥}, [symbol] [symbol] for some piece ⊥/∈F forever absent from the system, and denote by \hat{T}=T∪{ [symbol] {⊥}, [symbol] [symbol] } the extended set of types, including the seed.

Denote by n [symbol] _{C,S} [symbol] , [symbol] C,S [symbol] ∈ T the number of type [symbol] C,S [symbol] peers in the current system. The total number of peers is then given by n:=Σ [symbol] _{C,S} [symbol] _{∈} T n [symbol] _{C,S} [symbol] . Represent the state of the system by

n=(n [symbol] _{C,S} [symbol] ) [symbol] _{C,S} [symbol] _{∈T} Eq. (2)

the vector of the number of peers in each type, and let [symbol] = [symbol] ^{|T| denote the set of all possible vectors n. Further denote by n}_{S},S ∈ 2 [symbol] \{ [symbol] } the number of peers with the set of pieces S in their caches:

ns=Σ_{C:C∈c}n [symbol] _{C,S} [symbol] Eq. (3)

The system evolution is then described by a Markov process [symbol] with state space D. The transition rates of this process depend on how pieces are uploaded by the seed and the peers; before defining formally these transition rates, we first describe how piece uploads take place.

The seed uploads pieces at instants of a Poisson process of rate U. At such instants, the seed contacts a peer selected uniformly at random among all peers present in the system (across all swarms), and replicates a piece in [symbol] to this peer. Similarly, at instances that follow a Poisson process of rate α>0, each peer contacts another peer (also selected uniformly at random among all peers) and replicates a piece from its cache.

The piece replicated when a source (either a peer or the seed) contacts a receiving peer is determined by a the source's piece selection policy. Formally, a piece selection policy for sources in type [symbol] C,S [symbol] ∈ \hat{T}, is denoted by

h [symbol] _{C,S} [symbol] (i, [symbol] C′,S′ [symbol] ,n),i∈ [symbol] , [symbol] C′,S′ [symbol] ∈T,n∈D

which is a function from F×T×D to [0, 1]. The function h [symbol] _{C,S} [symbol] (i, [symbol] C′,S′ [symbol] ,n) is the probability that the piece replicated is i, given that (a) the piece receiver is of type [symbol] C′,S′ [symbol] and (b) the system state is n at the contact time.

The following natural assumptions about the policies are made: (a) no piece is to be replicated if the receiver owns all pieces in the source's cache, otherwise, (b) exactly one piece in the source's cache absent from the receiver's cache is replicated. These assumptions imply that a policy h [symbol] _{C,S} [symbol] must satisfy:

Σ_{i∉S\S},h [symbol] _{C,S} [symbol] (i, [symbol] C′,S′ [symbol] ,n=0 Eq. (4a)

Σ_{i∉S\S},h [symbol] _{C,S} [symbol] (i, [symbol] C′,S′ [symbol] ,n=1 if S [symbol] S′ Eq. (4b)

Note that the family of policies defined by the equations 4a and 4b is quite broad. Consider a source of type [symbol] C,S [symbol] ∈\hat{T}, and a receiver of type [symbol] C′,S′ [symbol] ∈ T; then, the following are examples of policies in this family:
Random Novel [RN]: If S\S′≠, the source replicates a piece chosen uniformly at random from the set S\S′.
Rarest First [RF]: We first define the availability of a piece i∈ [symbol] to be the number of peers holding it, i.e., Σ_{S:i∈S}n_{S}. The source replicates the piece in S\S′ that has the least availability, with ties broken uniformly at random.
Priority Rarest First [PRF]: The source prioritizes pieces within the swarm of the receiver as follows. If (S\S′)∩C′≠, it replicates the piece in (S\S′)∩C′ that has the least availability. If (S\S′)∩C′ is empty but S\S′ is not, the source reverts to rarest first.
Priority Random Novel [PRN] can be defined in a similar fashion.

Assume that sources of the same type apply the same policy. The piece selection policy of the system is denoted by a tuple of h [symbol] _{C,S} [symbol] indexed by each [symbol] C,S [symbol] ∈\hat{T}, where all sources in type [symbol] C,S [symbol] apply the policy h [symbol] _{C,S} [symbol] in the tuple. Different policies h can co-exist across types: e.g., the seed may implement a random novel policy, while peers implement priority rarest first. Contrary to random novel, the RF and PRF policies depend on the system state n, and require knowledge of a global property (namely, the availability of pieces in S\S′); as such, they are harder to implement in a distributed fashion. In a centralized setting, which includes most present BitTorrent implementations, the availability is monitored by a distinguished peer called the swarm tracker. Alternatively, distributed techniques such as gossiping or sampling can be used to obtain an estimate of the availability. The main stability result of this invention assumes that the seed applies a random novel [RN] policy, while type [symbol] C,S [symbol] peers may choose any piece selection policy h [symbol] _{C,S} [symbol] that satisfies equations 4a and 4b.

Recall that n(t)∈D represents the state of the system at time t and that {n(t)}_{t∈} [symbol] ₊ is a Markov process. Using the above notation for piece selection policies, its transition rates can be formally defined as follows. Assume that the seed implements the random novel piece selection policy, while for any [symbol] C,S [symbol] ΕT, type [symbol] C,S [symbol] peers implement an arbitrary policy h [symbol] _{C,S} [symbol] satisfying equations 4a and 4b. Given a state n, let T_{c}(n) be the new state resulting from the arrival of a new peer in swarm C. Given [symbol] C,S [symbol] ∈T such that i∉S, and a state n such that n [symbol] _{C,S} [symbol] ≧1, let T [symbol] _{C,S} [symbol] _{,i}(n) denote the new state resulting from a type [symbol] C,S [symbol] peer downloading piece i. The positive entries of the generator matrix Q=(q(n,n′):n,n′∈) are given by:

$$q ( n , {T}_{c} ( n ) ) = {λ}_{c} \\ q ( n , {T}_{〈 C , S 〉 , i} ( n ) ) = \frac{{n}_{〈 C , S 〉}}{n} \times [ \frac{U}{K - \vert S \vert} + μ {\sum }_{\{ {C}^{′} , {S}^{′} \} ∈ T} {n}_{〈 {C}^{′} , {S}^{′} 〉} {n}_{〈 {C}^{′} , {S}^{′} 〉} ( i , 〈 C , S 〉 , n ] \qquad Eq . ( 5 )$$

Use the following standard definitions of stability and instability for systems modeled as a Markov process. A system is unstable if it is transient and the number of peers converges to infinity with probability one; and a system is stable if it is positive recurrent and it has a finite mean number of peers.

It is known that, for the above system, in the case of a single autonomous swarm, i.e., a system in which all peers are interested in downloading the file C= [symbol] . The stability region of such a system is determined under the random novel [RN] policy:

THEOREM 1. Consider a single swarm of peers requesting all pieces in [symbol] , in which both the seed and peers follow the random novel piece selection policy. The system is stable if λ [symbol] <U, and unstable if λ [symbol] >U.

It is also known that the so-called missing piece syndrome is the reason of instability when λ [symbol] >U. As discussed above, this syndrome arises when there are a large number of peers in the system that store all pieces in [symbol] except for one missing piece (all peers missing the same piece). When this set of peers, termed the one-club, is large enough, most of the contacts of new peers arriving in the system will be with such peers. The new peers thus quickly retrieve all pieces except the missing piece, thus joining the one-club set. Since peers holding the missing piece are few, departures from the one-club are mostly due to uploads by the seed; as a result, the departure rate of the one-club is close to the seed upload rate U. Since λ [symbol] >U, the rate of growth of peers in the one-club is positive, causing the size of this set to increase to infinity and resulting to instability.

Theorem 1 above has an immediate corollary in the case of multi-swarm systems. In particular, suppose that each swarm operates in an autonomous mode, independently and in isolation of other swarms. More specifically, peers in swarm C∈c contact and exchange pieces only with other peers in the same swarm. In addition, the seed divides its upload capacity across different swarms (possibly unevenly), serving each with an appropriate fraction of its total capacity. Finally, pieces that are stored and exchanged in swarm C are pieces in set C. Theorem 1 directly applies to each such swarm and, thus, describes the stability of each individual swarm. As such, it is easy to verify the following corollary:

COROLLARY 1. Consider a multi-swarm system operating in autonomous mode, and assume that both the seed and peers upload pieces according to the random novel policy. Then, the seed can allocate its upload capacity so that the system is stable if Σ_{C∈c}λ_{C}<U. Moreover, the system is unstable for all allocations of the seed's upload capacity if Σ_{C∈c}λ_{C}>U.

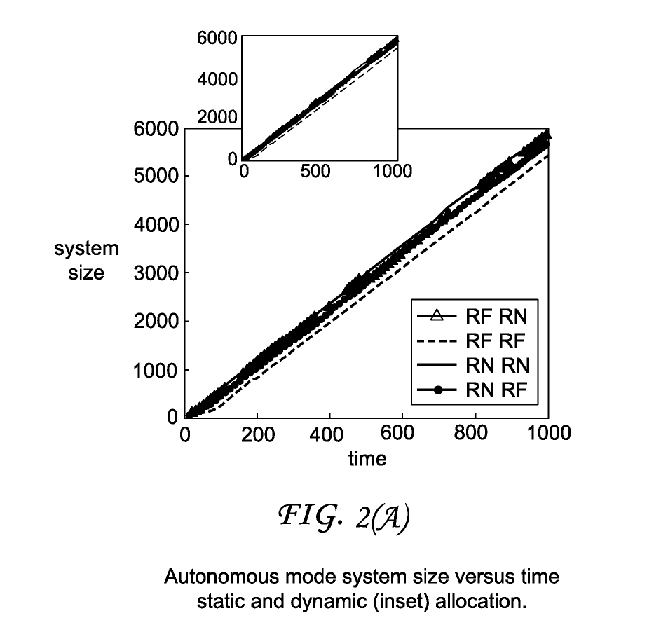

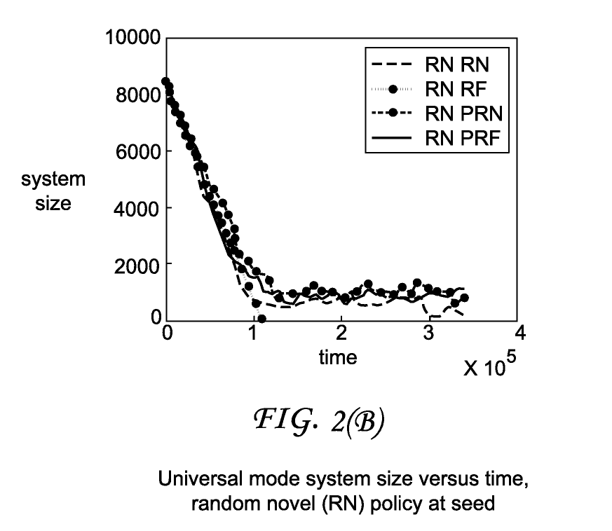

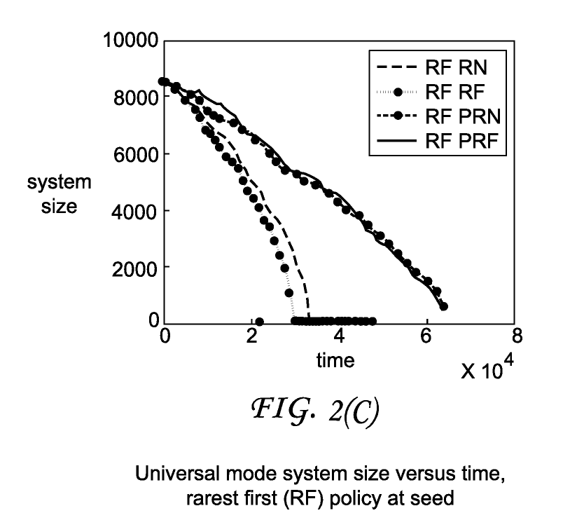

Stated differently, when operating in autonomous mode, the system can only support finitely many swarms with constant arrival rate: eventually the upload capacity of the seed will be depleted, and the system becomes unstable. Note that the corollary assumes a static allocation of a seed's rate to each swarm. The inventors have observed through simulations that an allocation that is proportional to the size of each swarm does not prevent the missing piece syndrome (see FIG. 2a).

A multi-swarm system is a system that operates to allow peers to contact other peers across swarms, and may exchange file pieces with them. To distinguish this type of system operation from that of peers operating in only a single swarm, the multi-swarm operation is termed operation in a universal mode or a universal swarm.

The inventors have shown that the stability region of the Markov process of equation (5) can indicate that universal swarms indeed exhibit improved stability.

THEOREM 2. Consider a universal swarm in which the seed implements the random novel policy and peers in type [symbol] C,S [symbol] implement any policy h [symbol] _{C,S} [symbol] that satisfies equations 4a and 4b. Then, (i) the system is unstable if

max_{i:i∈}_{^{F}}Σ_{C:i∈C}λ_{C}>U. Eq. (6)

and (ii) the system is stable if

max_{i:i∈}_{^{F}}Σ_{C:i∈C}λ_{C}<U. Eq. (7)

Beyond considering universal swarms, Theorem 2 extends Theorem 1 to the case where peers implement arbitrary piece selection policies under equations 4a and 4b. An immediate corollary of Theorem 2, applied to the single swarm setup, is that the stability region of Theorem 1 extends to such policies as well. Note also that the theorem assumes that the seed uses random novel policy. The inventors have determined that using the rarest first policy at the seed also exhibits the same stability region.

Note that the theorem implies that bundling swarms together yields a significant increase in the stability region. To see this, observe that, when the files C∈c are disjoint, equation (7) becomes max_{C∈c}λ_{C}<U. This defines a larger stability region than the one achieved by a system operating in autonomous mode, given by Corollary 1. In particular, by bundling swarms together, the inventors have found that the stability region scales extremely well as the number of swarms increases: a single seed can support an unbounded number of swarms with constant arrival rate, with no effect on the stability region. However, bundling swarms together comes at the cost of increased delays. Hence, the number of swarms cannot be arbitrarily large in practice.

Thus, the present invention includes a hybrid system that, by alternating between the universal and autonomous mode, maintains the same stability region as a universal swarm while also ensuring small delays for large numbers of swarms. The invention implements a multiple threshold piece selection policies that allow the system to alternate between autonomous and universal swarm behavior. In particular, whenever the system size is small, each swarm acts autonomously: the seed evenly distributes its uploading capacity to different swarms, while peers in each swarm contact only other peers within the same swarm and receive only pieces they are interested in. However, when the system size becomes high (i.e., the missing piece syndrome manifests), we switch to a universal mode: peers contact peers in other swarms, and receive arbitrary pieces in F from each other and the seed. Switching to the universal mode ensures that the system is stabilized, and eventually led back to the autonomous mode. The inventors have observed that the stability region of the hybrid system remains the same irrespective of which piece selection policy is implemented at peers (e.g., random novel, rarest first or priority rarest first, or combinations thereof).

The hybrid system was evaluate in terms of the performance of universal swarms using simulations that studied swarm behavior for different piece selection policies, as well as for the dependence of the sojourn time in swarm parameters. As before, the terms RF, RN, PRN and PRF correspond to the piece selection policies rarest first, random novel, priority random novel and priority rarest first respectively. Note that PRF and PRN reduce to RF and RN when the system operates in autonomous mode.

Theorems 1 and 2 can be validated by studying the evolution of the system size n in autonomous and universal mode for a system comprising 3 swarms, each requesting a different 3-piece set. The seed rate is U=3.1 and the arrival rate in each swarm is λ=3.0; note that Theorems 1 and 2 imply that the autonomous mode is unstable while the universal system is stable, in this regime.

FIG. 2a shows the evolution of the system size in autonomous mode, when the seed statically allocates ⅓ of its upload rate to each swarm, for different combinations of policies at the seed and the peers. All simulations start from an empty system. Even though applying the rarest first policy at both the seed and the peers leads to a slightly smaller system size, the missing piece syndrome manifests in all four cases. Repeating these experiments with the seed allocating its rate dynamically, so that each swarm receives pieces at a rate proportional to its size results in the inset plot of FIG. 2a that shows instability persists in this setup too.

These experiments are repeated in universal mode, this time starting the system from an initial state comprising 8500 peers forming a one-club, where all peers belong to a single swarm, requesting the same file, and store in their cache all nine pieces except for one piece they request (all missing the same piece). FIG. 2b shows the system evolution when the seed applies the random novel policy; indeed the system stabilizes after 10⁵ time units, confirming Theorem 2. The system stabilizes faster (in the order of 10⁴ time units) when the seed applies the rarest first policy, as seen in FIG. 2c, with rarest first at both seed and peers stabilizing the system the fastest (in roughly 3·10⁴ time units). Interestingly, prioritizing pieces at peers (through either PRN or PRF) leads to slower stabilization: this is precisely because these policies reduce the diversity of pieces in the system.

Consider the same experiments as above with a seed rate of U=2.9. As the arrival rate at each swarm is λ=3, Theorem 2 stipulates that when the seed applies the random novel policy the system is unstable. One question is how quickly the missing piece syndrome manifests in this case, depending on which piece selection policy is used at the seed or the peers. The following experiments were conducted for a seed applying the random novel (RN) or the rarest first (RF) policy. The simulations start with initial system size n₀, where the initial state comprises all peers forming a one club (i.e., storing all pieces but one). The simulation is terminated when either the system size reaches the threshold maximum (2000+n₀, 2n₀) or the simulation time reaches 10⁷ time units, whichever occurs first. For each of the four policies at peers (RN, RF, PRN, PRF), this experiment was first conducted with an empty initial state n₀=0; if the experiment does not reach the threshold in 10⁷ units, n₀ is increased by 100 and the experiment is repeated. This way, the critical one-club size is identified. If the system reaches a state with a one club of that size, it becomes unstable.

The simulation results for the case where the seed uses the RN policy are summarized in the top half of Table 1. The missing piece syndrome indeed manifests at the critical initial conditions, with the one-club comprising more than 90% of the peer population at termination time. When peers use any policy other than RF, the critical one club size is 0. In contrast, when peers use the RF policy, the syndrome manifests only when n₀=500; indeed, using the rarest first policy improves the diversity of pieces in the system, which in turns makes reaching a critical one-club size more difficult. This behavior becomes even more striking when the seed uses the RF policy rather than the RN policy: as shown in the bottom half of Table 1, using RF policy at the seed ensures piece diversity is so high that critical one-club sizes lie between 2 and 8 thousand peers.

Crucially, in all simulations starting from an initial size below the critical value, the following very interesting behavior is observed: the system size actually decreases to a size below 200 and lingers around this value for the entire 10⁷ time units. This implies that, though the system is clearly not stable in any of the cases in Table 1, applying RF policy at either the seed or the peers yields meta-stability. Although there exists a critical one-club size, its value is so high that it is quite hard to reach from the “typical” size at which the system operates most of the time (˜200 peers in the simulations).

TABLE 1
Critical One Club Size

| Policy | | Critical | Final | Final One | Simulation |
|---|---|---|---|---|---|
| Seed | Peer | n₀ | Size | Club Ratio | Duration |
| RN | PRN | 0 | 2000 | 95.6% | 13181 |
| | PRF | 0 | 2000 | 95.4% | 17211 |
| | RN | 0 | 2000 | 93.3% | 13603 |
| | RF | 500 | 2500 | 94.7% | 22655 |
| RF | PRN | 2100 | 4200 | 98.1% | 74655 |
| | PRF | 2000 | 4000 | 98.0% | 51415 |
| | RN | 8000 | 16000 | 99.4% | 283197 |
| | RF | 8100 | 16200 | 99.4% | 323738 |

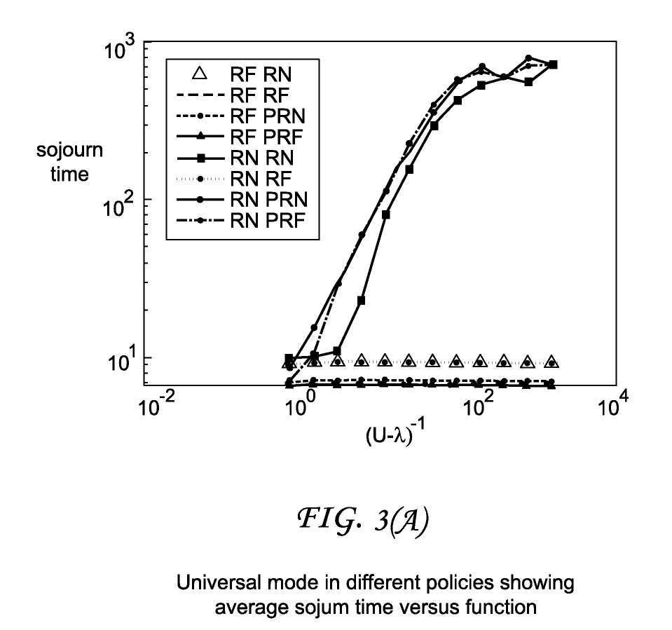

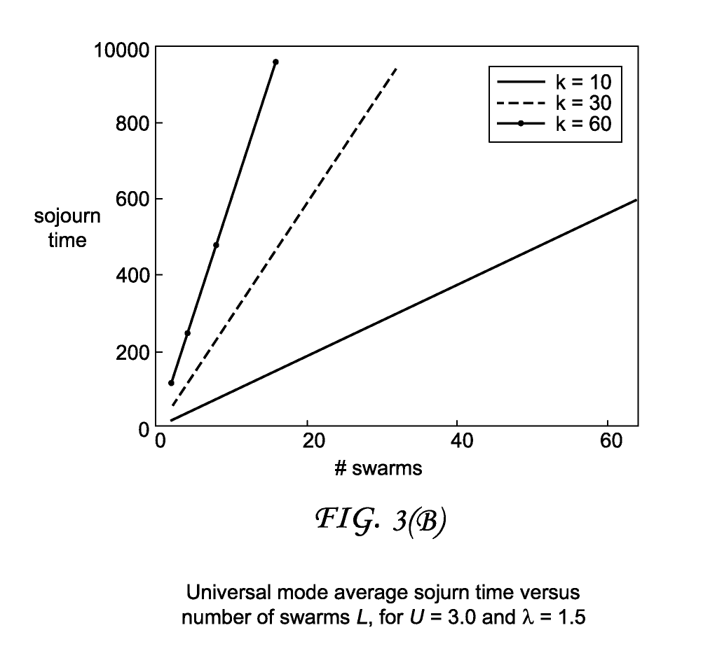

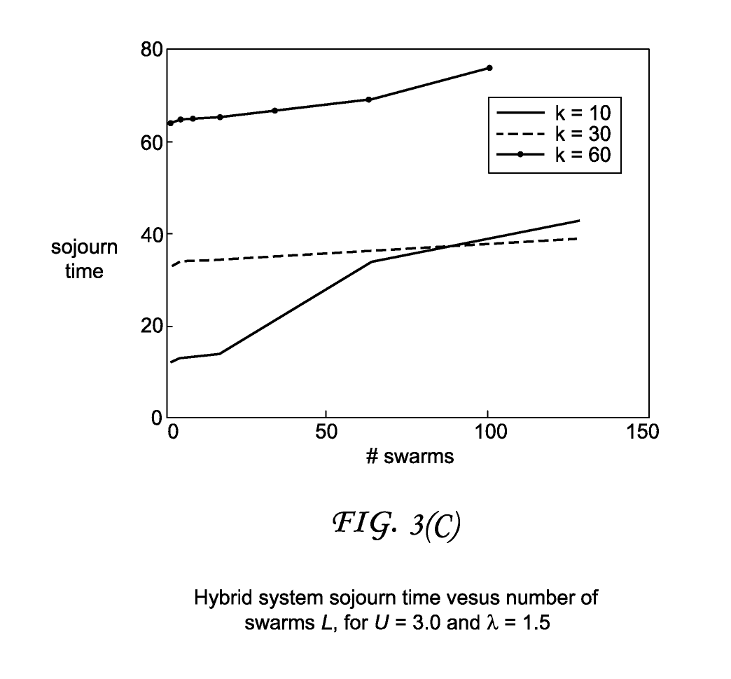

Sojourn time is the time peers spend in the file sharing system obtaining the desired file. The average sojourn time for a universal system comprising 3 swarms with 3 pieces each can be determined. The seed upload rate is set to U=3.0 and the arrival rate λ can be varied at each swarm as λ=U(1−½ⁱ), for i=1, . . . , 10, remaining thus within the stability region, but approaching U from below. FIG. 3a plots the average sojourn time in a universal mode for different piece selection policies as a function of 1/(U−λ) (higher values correspond to λ closer to U). As λ approaches U, the sojourn time under the RN policy at the seed increases considerably, with the exception of the RN-RF case, i.e., when peers use the rarest first policy. In all four cases for which the seed uses the RF policy, the sojourn time remains practically constant as the arrival rate approaches U. This is consistent with the fact that, by meta-stability, when the seed uses the RF policy the system size remains small most of the time even when λ>U; as such, there is no sharp increase in the sojourn time as the arrival rate approaches U from below.

FIG. 3b is a plot of average sojourn time versus swarm size L in a universal mode for the case where each swarm comprises peers requesting a k-piece file, for k ∈{10, 30, 60}. Note that the total number of pieces at each simulation is K=kL. First, observe that across all values of k, the average sojourn time increases linearly as the number of swarms increases. Similarly, the sojourn time also increases proportionally to k, the number of pieces per swarm. The delay a peer experiences is of the order of K=kL, and, as such, does not scale well with the number of swarms L. In other words, the increased stability offered by bundling swarms together in a universal mode comes at the cost of increased delays. Using the current invention, delays can in fact be suppressed for a wide range of values of L by using the inventive hybrid approach, alternating between the universal and the autonomous mode.

Interpreting the simulation results suggests that, in a meta-stable swarm, there are two important system sizes: the operating size nₒₚ, which is the size around which the system stays most of the time, and the critical size n₀, which is the size of a one-club that, once attained, leads the system to instability. If the two sizes are sufficiently far apart from each other, the system will exhibit meta-stability. When near the operating size, it will take a long time for the system to reach a critical state, from which the missing piece syndrome manifests.

The inventors have derived some simple estimates of nₒₚ and n₀ when (a) the system comprises of a single swarm, (b) the arrival rate is λ>U, and (c) both the seed and peers use the RF policy. In particular, the operating size of such a single swarm system can be estimated by:

nₒₚ≈λK/μ Eq. (8)

while the critical system size, which once attained leads to instability, can be approximated by:

n₀≈λ(K−1)μ[(U(K−1)/2λ−U)−1] Eq. (9)

Using these two estimates, an inventive hybrid system can be realized that attains the increased stability region of the universal swarm, while also ensuring that the sojourn times remain small for a wide range of swarm numbers L. The hybrid system alternates between the autonomous mode, whereby swarms operate in isolation while sharing a U/L portion of the seed's uplink capacity, and the universal mode, where swarms are bundled together. In particular, consider a multiswarm system with L swarms, each requesting a file of k=K/L pieces. The system switches between the two modes according to the following rules:
(a) If in autonomous mode, the system switches to universal mode if any single swarm has size greater than nₒₚ+max(n₀, 2nₒₚ). That is, the system switches to universal mode if any single swarm has size greater than either (n₀+nₒₚ) or 3nₒₚ.
(b) If in universal mode, the system switches to autonomous mode if each piece requested by a swarm is held by at least max(nₒₚ/10, 1) peers within the swarm. That is, the system switches back to autonomous mode if any single swarm has size greater than either (nₒₚ/10) or 1.
   where nₒₚ, n₀ are computed by equations 8 and 9 respectively, assuming an upload rate U/L and a number of pieces k.

Intuitively, the universal mode is applied when there is strong evidence that the missing piece syndrome is manifesting, as the swarm size becomes greater than nₒₚ+n₀. The system reverts to an autonomous mode when there is enough diversity in each swarm. Thia is, when each piece is held by at least 10 percent (one tenth) of the peer population at the operating state.

The piece selection policy of this hybrid system satisfies equations 4 and 4b, so it exhibits the increased stability region of universal swarms. FIG. 3c shows the sojourn time of this hybrid system as the number of swarms increases. In contrast to FIG. 3b, for k=30 and k=60, the sojourn time stays close to the value attained when L=1 (˜33 and ˜64 time units, respectively). For k=10, the sojourn time stays also close to the value attained when L=1 (˜12 time units), however it starts increasing linearly after L=12.

These improved sojourn times appear precisely because of the meta-stability of the system. Indeed, swarms operate fine most of the time without the intervention of other swarms, and this is why they experience the same delay as if L=1. As U/L<λ, the autonomous mode is unstable; however, at the few (and rare) occasions when the missing piece syndrome manifests, bundling swarms together ensures the system quickly stabilizes and reverts to its operating size.

The knee of the curve observed for k=10 of FIG. 3c suggests that this behavior cannot be sustained for arbitrarily large L. Equations 8 and 9 help give an approximate answer to how large L can be. Indeed, for the system to be meta-stable, the critical one-club size must be significantly larger than the operating size. Requiring that n₀>2nₒₚ, so that the missing piece syndrome rarely manifests, and taking K/(K−1)≈1, gives the following heuristic for meta-stability when L=1: K U/λ−U>6. Considering now L>1 swarms in autonomous mode, each requesting k=K/L pieces. Each swarm gets a U/L upload rate in autonomous mode. Then, the above condition becomes:

L<U/6(λ−U/L)k≈kU/λ6

In other words, the hybrid system can support a number of swarms L with small delay so long as L is of the order of k, the number of pieces in each swarm. As the number of pieces in a file typically numbers in the thousands, this implies that the above system can sustain low sojourn times for a large number of swarms, in practice.

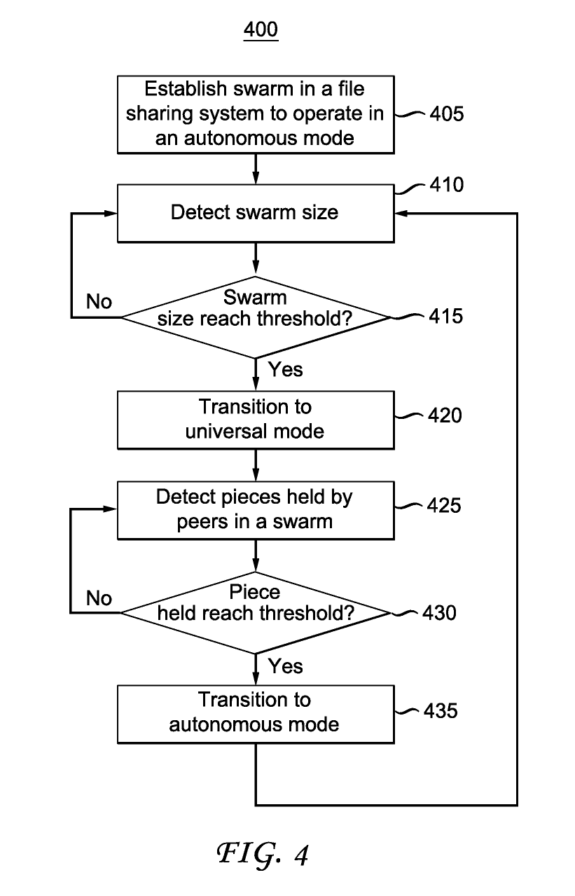

FIG. 4 depicts an example flow diagram 400 according to aspects of the invention. The process 400 is monitored and controlled by a network device, such as the swarm tracker apparatus 120 of FIG. 1. Initially, the apparatus establishes a swarm of peer network devices in a file sharing system configuration. The swarm operates to share pieces of a desired file donated by a distinguished user, seed device, or peer. In one embodiment, the seed may be the swarm tracker apparatus 120. At step 405, the swarm is established to operate in an autonomous mode where one or more swarms operate in isolation. Each peer in a swarm of peers communicating only with peers of its own swarm to transfer pieces of a desired file.

At step 410, the swarm tracker monitors and detects the swarm size while remaining in the autonomous mode. Monitoring the file sharing system can occur using a file sharing network interface of the swarm tracker. In one embodiment, the swarm tracker has processing capability to monitor and analyze network operations and transactions so as to be able to determine swarm size. At step 415, the swarm size is compared to a first threshold. In one embodiment, the first threshold is defined as swarm that has a size greater than nₒₚ+maximum of either n₀ or 2nₒₚ. That is, the first threshold is defined as the greater of nₒₚ+n₀ or 3 nₒₚ where nₒₚ is the operating size and n₀ is the critical size as discussed hereinabove. If the swarm size is less than the first threshold, the process 400 moves back to step 410 where the swarm size continues to be monitored. If the swarm size meets the first threshold, then the process 400 moves to step 420.

At step 420, the system moves to the universal mode where multiple swarms are bundled together and where peers from one swarm may transfer pieces of the desired file from a peer in one swarm to a peer in a different swarm. In one embodiment, moving to universal mode is accomplished via a swarm tracker that is monitoring the progress and controlling the rules by which peers operate in the file sharing system. In the case of step 420, where the first threshold is met, the swarm tracker allows peers to seek desired file pieces from different swarms.

At step 425, pieces held by peers in a swarm are detected while the system 400 operated in a universal mode. Monitoring the files sharing system can occur using a file sharing network interface of the swarm tracker. In one embodiment, the swarm tracker has processing capability to monitor and analyze network operations and transactions so as to be able to detect how many peers hold pieces of a desired file in a swarm. At step 430, a second threshold is determined. The second threshold is reached if each desired file piece requested by a swarm is found to be held by at least either nₒₚ/10 or 1 peer in a swarm, whichever is greater. If the number of peers holding a desired file piece in a swarm is less than the second threshold, the process 400 moves back to step 425 where the desired file pieces held by peers in a swarm continues to be monitored. If the desired file pieces held by peers in a swarm meets the second threshold, then the process 400 moves to step 435.

At step 435, the system 400 transitions back to an autonomous mode. This switch back to an autonomous mode is advantageous because operation in the universal mode is no longer needed. That is, there are enough peers in a swarm that contain desired file pieces to avoid a missing piece syndrome. This allows autonomous mode operation to be successful for all peers without incurring excessive sojourn time. From step 435, a system may move back to step 410 where swarm size is detected to monitor operations in the autonomous mode.

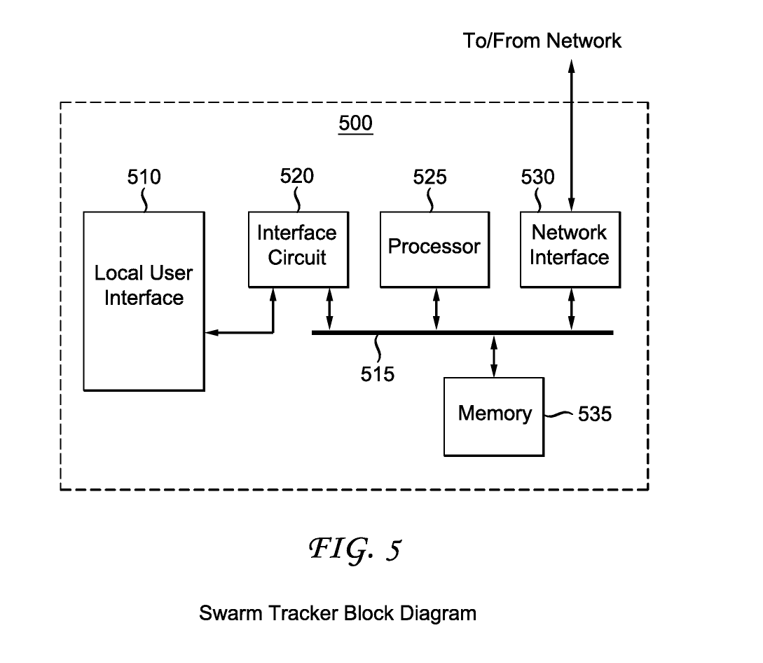

FIG. 5 depicts an example apparatus 500 operating on a network suitable for file sharing. Apparatus 500 controls and monitors the file sharing environment. In one embodiment, the apparatus 500 is the swarm tracker 120 of FIG. 1. In FIG. 5, the apparatus 500 may typically contain a local user interface 510. A local user interface may include human and electronic interfaces known to those of skill in the art such as a keyboard, mouse, display, USB connections, and the like for a user to conduct programming and apparatus operational control. Apparatus 500 may contain an interface circuit 520 to couple the user interface 510 with the internal circuitry of the device, such as an internal bus 515 as is known in the art. A processor 525 assists in controlling the various interfaces and resources for the apparatus 500. Those resources include a local memory 535 used for program and/or data storage and well as a network interface 530. The network interface 530 is used to allow the apparatus 500 to communicate with the network. The network in turn, allows apparatus 500 to exchange data with peers on the file sharing system. For example, the network interface 530 can be a wired or wireless interface for the functionality described for peer devices A though D of FIG. 1. Apparatus 500 utilizes the processor 525, memory 535, and network interface 530 to conduct monitoring and controlling of a file sharing network as described in the example flow diagram of FIG. 4.

Although specific architectures are shown for the implementation of a swarm tracker in FIGS. 1 and 5, one of skill in the art will recognize that implementation options exist such as distributed functionality of components, consolidation of components, and use of distributed programming between peer devices and the swarm tracker. Such options are equivalent to the functionality and structure of the depicted and described arrangements.

1. A method for controlling the average time a peer spends in a swarm of peers in a file sharing system, the method comprising:
establishing an autonomous mode of operation in the swarm;
changing from the autonomous mode to a universal mode of operation at a first threshold based on a size of the swarm;
changing from the universal mode back to the autonomous mode at a second threshold;
wherein a peer in the swarm contacts only other in the swarm while operating in the autonomous mode, and wherein the peer in the swarm contacts other peers in a different swarm in the universal mode.

2. The method of claim 1, wherein the autonomous mode comprises sharing files between peers in the swarm of peers.

3. The method of claim 1, wherein the universal mode comprises peers sharing files between bundles of different swarms.

4. The method of claim 1, wherein the first threshold comprises the swarm increasing to a threshold size.

5. The method of claim 4, wherein the first threshold size comprises three times a normal operating size.

6. The method of claim 4, wherein the first threshold size comprises the sum of a normal operating size and a critical size.

7. The method of claim 1, wherein the second threshold comprises a condition wherein a missing file piece is held by at least 10 percent of the peers in the swarm.

8. An apparatus for monitoring and controlling a file sharing system, the apparatus comprising:
a network interface for communicating with one or more peer devices on the file sharing system;
a processor that executes a program to determine a size of a swarm of peers and the number of peers having file pieces requested by the swarm;
memory, available to the processor for storing the program, wherein when the program is executed by the processor, the program establishes an autonomous mode of operation in the swarm and changes from an autonomous mode to a universal mode upon a first threshold based upon the size of the swarm of peers, thereafter changing from the universal mode back to the autonomous mode upon a second threshold.

9. The apparatus of claim 8, wherein the processor changes from the autonomous mode to the universal mode when the size of the swarm meets the first threshold.

10. The apparatus of claim 8, wherein the processor changes from the universal mode back to the autonomous mode when the number of peers having file pieces requested by the swarm meets the second threshold,
wherein a peer in the swarm contacts only other peers in the swarm while operating in the autonomous mode, and wherein the peer in the swarm contacts other peers in a different swarm in the universal mode.
